(19) United States
(12) Patent Application Publication
(10) Pub. No.: US 2006/0186856 A1
(43) Pub. Date: Aug. 24, 2006

(54) Jumper cable accessory device

(76) Inventor: Milton Lavern Lott, Minneapolis, KS (US)

Correspondence Address: MILTON L. LOTT, 234 LAUREL STREET, Minneapolis, KS, 67467, US

(21) Appl. No.: 11/357,516

(22) Filed: Feb. 21, 2006

Related U.S. Application Data
(60) Provisional application No. 60/655,629, filed on Feb. 24, 2005.

(51) Int. Cl. H02J 7/00

(52) U.S. Cl. 320/105

(57) ABSTRACT

A Jumper Cable Accessory which includes a sleeve/cap. A body member consisting of a strap. A slot located at the end of the strap located to the opposite end of the location of the sleeve/cap.

### CROSS REFERENCE TO RELATED APPLICATION

This is a utility accessory based upon and incorporating, by reference previously filed provisional application Ser. No. 60/655,629 filed Feb. 24, 2005.

### BACKGROUND OF THE INVENTION

The principal aspect of the present invention relates to improvement in using and handling Jumper Cables.

The purpose of this Jumper Cable Clamp Accessory is to make the use of the jumper cables more user friendly by greatly reducing the clamp ability to catch and hook on almost everything they come in contact with during the removal, use and return to their place of storage.

Most all farmers, law enforcement personal, auto mechanics, auto and industrial service personnel and emergency personnel such as tow truck operator have and carry with them “Jumper Cables”. Thus developing a need for a means to ease the handling of such.

It is sometimes frustrating, time consuming and dangerous when attempting to use Jumper Cables, given the clamps ability to catch and hook on most anything they came in contact with. This device will greatly reduce this frustration and hazards of using the cables.

### SUMMARY OF THE INVENTION

Briefly the present invention is comprised of a cap that is attached to a strap. FIGS. 1 and 2 illustrates this alone and installed on Jumper Cable clamp.

### BRIEF DESCRIPTION OF THE DRAWINGS

FIG. 1 comprises a profile of this device in 2 different views showing approximate sizes length and shapes. FIG. 2 comprises a profile of the jumper cable accessory attached to said jumper cable.

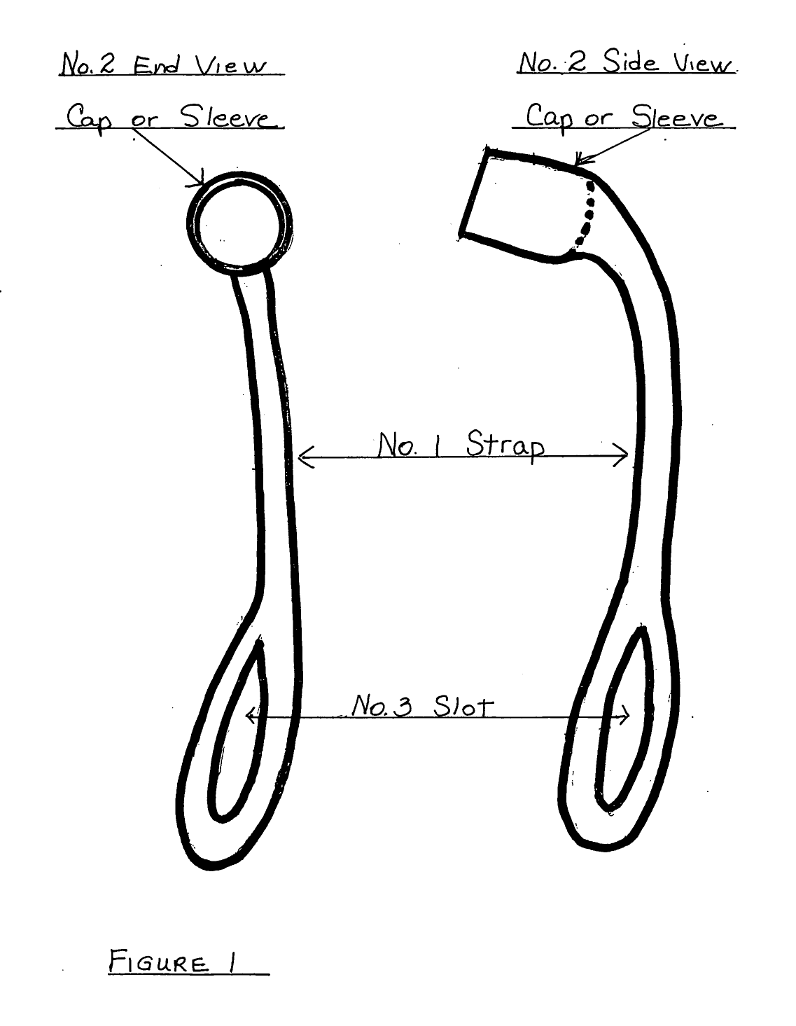

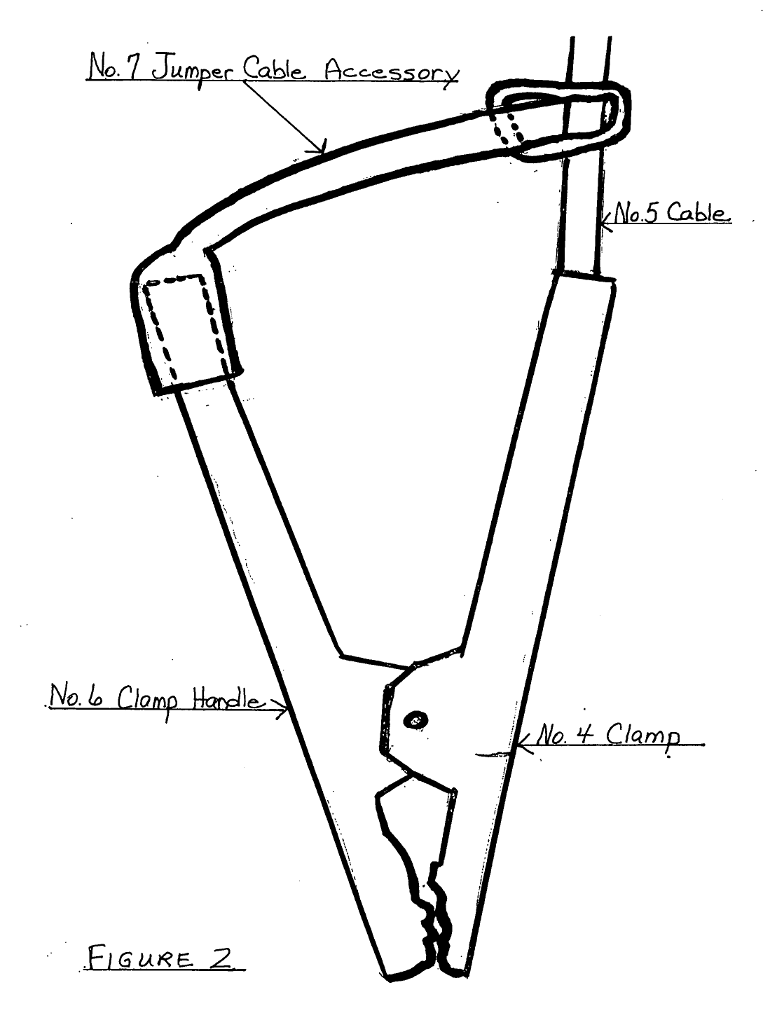

A “cap sleeve” part “no. 2 FIG. 1” is produced to slide onto clamp handle as illustrated by “No. 6 FIG. 1”, it maybe constructed of any suitable material that will accomplish the objective. A strap “No. 1 FIG. 1” is attached to amd manufactured into “cap sleeve”. A sufficient slot “No. 3 FIG. 1” is incorporated into trail end of No. 1 strap to allow attachment to and around the jumper cable “No. 5 FIG. 2” itself

All length and sizes that are illustrated in FIGS. 1 and 2 are approximate and maybe altered to fit a variety of Jumper Cable Assemblies.

1. A Jumper Cable Accessory capable of assisting in the ease of handling and use of jumper cables comprising in combination:
a) Sleeve Cap
b) Strap
c) Slot

2. Sleeve/cap of claim 1 designed to slide onto and grip handle of clamp

3. Strap of claim 1 is connected to and incorporated in the Sleeve/Cap

4. Slot of claim 1 is incorporated in strap.
